(19) United States
(12) Patent Application Publication
(10) Pub. No.: US 2004/0250176 A1
(43) Pub. Date: Dec. 9, 2004

(54) Generating a status report from source code

(76) Inventors: Christopher W. Brown, Fort Collins, CO (US); Shane B. Unruh, Windsor, CO (US); Paul D. Grubb, Fort Collins, CO (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/454,424

(22) Filed: Jun. 3, 2003

(51) Int. Cl. H04B 1/74

(52) U.S. Cl. 714/50

(57) ABSTRACT

Methods and Systems for generating a status report from source code is described. Data that describes the status of one or more tasks associated with a source code file is received. The data is maintained as a part of the source code file. A status report is generated based on the data.

### TECHNICAL FIELD

Embodiments of the present invention relate to tracking the progress of developing software. More specifically, embodiments of the present invention relate to generating status reports for the purpose of tracking the progress of developing software.

### BACKGROUND ART

As a part of developing software, there is a need for tools to track the progress of developing the software. For example, a project manager needs software tracking tools to assess the progress of developing the software in a project. If the development is behind schedule, certain corrective measures need to be taken, such as reassessing the schedule for developing the software, re-assigning the development of certain features to other programmers, or determining simpler designs that can be implemented within the software project's schedule.

In a first solution, the information for tracking the progress of developing software was formatted with a non-industry-standard format. Therefore, the status report generator was not platform independent. Additionally, in the first solution only the progress of developing source code files was tracked. Therefore, the project manager did not have information at a fine enough granularity to accurately track the progress of the project.

In a second solution, each programmer entered their own status of developing the work assigned to them in either a file or an email they sent to the project manager. The inconvenience of this solution resulted in the project manager receiving out of date information.

For these and other reasons, a need exists for a method and/or a system that provides a status report with sufficient granularity to accurately track the work performed on source code files. A further need exists for a method and/or system that meets the above need but also provides real time data in the status report. A further need exists for a method and/or a system that is implemented according to an industry-standard.

### DISCLOSURE OF THE INVENTION

The present invention provides a status report with sufficient granularity to accurately track the work performed on source code files. The present invention provides real time data in the status report. The present invention provides a status report generator that is implemented according to an industry-standard.

Embodiments of the present invention pertain to methods and systems for generating a status report from source code is described. In one embodiment, data that describes the status of one or more tasks associated with a source code file is received. The data is maintained as a part of the source code file. A status report is generated based on the data.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of an exemplary computer system upon which embodiments of the present invention can be implemented.

FIG. 2 is a block diagram of an exemplary software system in which embodiments of the present invention can be implemented.

FIG. 3 and FIG. 4 depict flowcharts for generating a status report from source code according to embodiments of the present invention.

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

### Hardware Overview

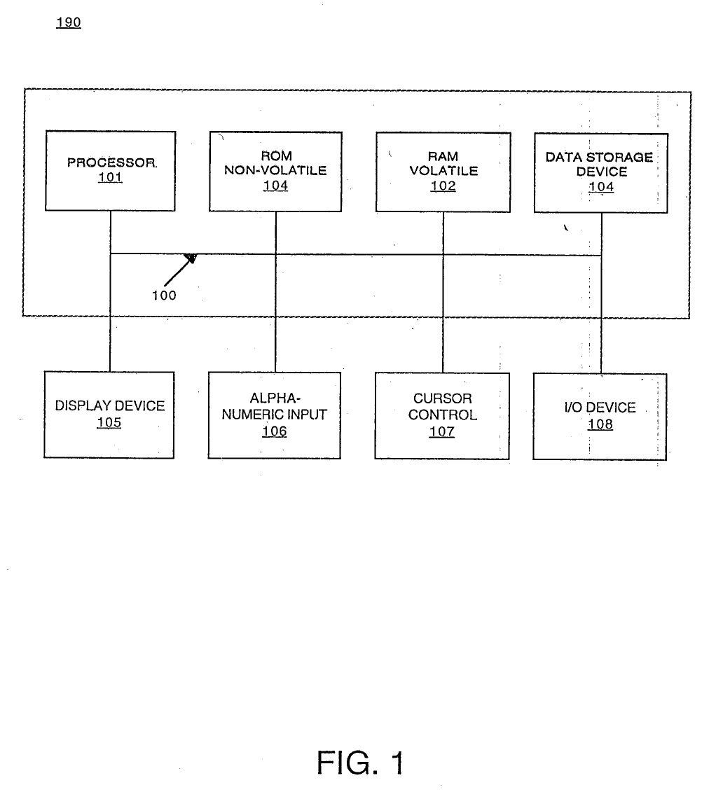

FIG. 1 illustrates an exemplary computer system 190 upon which embodiments of the present invention may be practiced. In general, computer system 190 comprises bus 100 for communicating information, processor 101 coupled with bus 100 for processing information and instructions, random access (volatile) memory (RAM) 102 coupled with bus 100 for storing information and instructions for processor 101, read-only (non-volatile) memory (ROM) 103 coupled with bus 100 for storing static information and instructions for processor 101, data storage device 104 such as a magnetic or optical disk and disk drive coupled with bus 100 for storing information and instructions, an optional user output device such as display device 105 coupled to bus 100 for displaying information to the computer user, an optional user input device such as alphanumeric input device 106 including alphanumeric and function keys coupled with bus 100 for communicating information and command selections to processor 101, and an optional user input device such as cursor control device 107 coupled to bus 100 for communicating user input information and command selections to processor 101. Furthermore, an optional input/output (I/O) device 108 is used to couple computer system 190 onto, for example, a network.

Display device 105 utilized with computer system 190 may be a liquid crystal device, cathode ray tube, or other display device suitable for creating graphic images and alphanumeric characters recognizable to the user. Cursor control device 107 allows the computer user to dynamically signal the two-dimensional movement of a visible symbol (pointer) on a display screen of display device 105. Many implementations of the cursor control device are known in the art including a trackball, mouse, joystick or special keys on alphanumeric input device 106 capable of signaling movement of a given direction or manner of displacement. It is to be appreciated that the cursor control 107 also may be directed and/or activated via input from the keyboard using special keys and key sequence commands. Alternatively, the cursor may be directed and/or activated via input from a number of specially adapted cursor directing devices.

### Software System and Functional Overviews

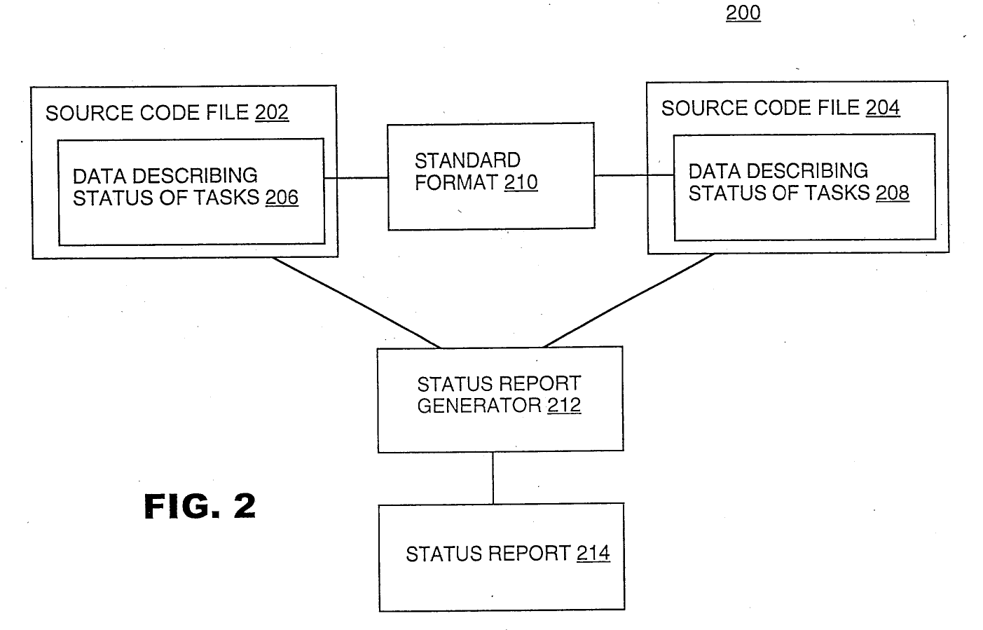

FIG. 2 is a block diagram of an exemplary software system in which embodiments of the present invention can be implemented. The blocks in FIG. 2 can be arranged differently than as illustrated, and can implement additional features that are not described herein.

The software system 200 includes two source code files 202 and 204, which respectively include, among other things, data describing the status of tasks 206 and 208, a standard format 210, a status report generator 212, and a status report 214.

For the purposes of explanation, assume that the source code files 202 and 204 are either initially developed or enhanced in a particular software project. The work involved in developing or enhancing the source code files 202 and 204 and the time periods or cycles for completing the work have been determined. For example, the work to be completed on the software project may include implementing a protocol for communication and implementing the messages the protocol uses. Since, the protocol uses the messages, it may be advantageous to schedule the implementation of messaging in a time period prior to the implementation of the protocol.

In one embodiment, the work is partitioned into tasks that can be implemented within an assigned fixed length of time. For example, the fixed length of time assigned for completing any task may be 3 days. The work may then be partitioned into tasks that can be completed in 3 days. For example, different types of messages may all be implemented in 3 days. Therefore, the work involved in implementing four types of messages may be partitioned into 4 tasks.

In the present embodiment, as programmers implement the tasks in source code files 202 and 208, they enter data describing the status of tasks 206 and 208, thus, providing real-time information that may be used in generating the status report 214. For example, the four types of messages may be implemented in source code file 202. The programmers may update the data describing the status of tasks 206 as they implement the four types of messages in source code file 202, as will be described in more detail.

In the present embodiment, the data describing the status of tasks 206 and 208 conforms to a standard format 210. In one embodiment, the standard format 210 is an industry-standard format, as will be described in more detail herein.

In the present embodiment, the status report generator 212 receives the data describing the status of tasks 206 and 208 and generates the status report 214 based on the data describing the status of tasks 206 and 208. In one embodiment, the status report generator 212 is installed and/or executes on the computer system 190, as depicted in FIG. 1.

### The Format of the Data Describing the Status of the Tasks Conforms to an Industry-Standard

Table 1 below depicts exemplary data describing the status of tasks that conforms to an industry-standard format according to one embodiment of the present invention. The reference numbers to the left are used to delineate the lines of the exemplary data to facilitate discussion of the data and the format the data conforms to.

TABLE 1
EXEMPLARY DATA DESCRIBING THE STATUS OF TASKS

| Line | | |
|---|---|---|
| Number | Exemplary data describing the status of tasks | |
| 1 | @task name = protocol sessions | |
| 2 | owner = John | |
| 3 | cycle = 2 | |
| 4 | phase = Design | |
| 5 | phase-state = Planned | |
| 6 | | description = the client and server establish session before |
| 7 | communicating with the messages | |
| 8 | | |
| 9 | @task name = protocol state machine | |
| 10 | owner = John | |
| 11 | cycle = 2 | |
| 12 | phase = Design | |
| 13 | phase-state = In Progress | |
| 14 | | description = a state machine is used to determine the state |
| 15 | of communication between the client and the server. For | |
| 16 | example, one state may be that the client has transmitted a | |
| 17 | message to the server and is waiting for an acknowledgement | |
| 18 | from the server. | |
| 19 | | |
| 20 | @task name = message type A | |
| 21 | | owner = Shane |
| 22 | | cycle = 1 |
| 23 | | phase = Code |
| 24 | | phase-state = Planned |
| 25 | | |
| 26 | @task name = message type B | |
| 27 | | owner = Cheryl |
| 28 | | cycle = 1 |
| 29 | | phase = Code |
| 30 | | phase-state = Review Needed |

In the present embodiment, as illustrated in Table 1, data describing the status of four tasks is depicted. For example, data describing the status of the first task is depicted from lines 1 to 7; data describing the status of the second task is depicted from lines 9 to 18; data describing the status of the third task is depicted from lines 20 to 24; and data describing the status of the fourth task is depicted from lines 26 to 30.

There are many types of data that may be used to describe the status of tasks. In the present embodiment, the data describing the status of tasks includes, but is not limited to: the name of the task, the owner or person responsible for the task, the period of time or cycle that the task is to be completed in, the phase and phase-state that the task is currently in, and optionally the description of the task, as will be described in more detail.

In the present embodiment, the data describing the status of tasks is formatted with tags, sub-tags, and values that are associated with the sub-tags.

In the present embodiment, the “@” character is used to designate the tags, as will be described in more detail hereinafter. In table 1, the “@” character designates “task” as a tag. In the present embodiment, several sub-tags follow the task tag. Examples of sub-tags include, but are not limited to “name”, “owner”, “cycle”, “phase”, “phase-state”, and optionally “description”.

In the present embodiment, values are associated with the sub-tags. For example, on line 1, the value “protocol sessions” is associated with the sub-tag “name” to indicate that the task is for protocol sessions. Similarly, on line 2, the value “John” is associated with the “owner” sub-tag to indicate that John is the owner of the first task. On line 3, the value “2” is associated with the “cycle” sub-tag to indicate that the task is to be completed in the second time period or cycle. On line 4, the value “design” is associated with the “phase” sub-tag to indicate the task is currently in the “design” phase. On line 5, the value “planned” is associated with the “phase-state” sub-tag indicating that the owner, John, plans on starting the design phase for the protocol sessions task. On lines 6 and 7, the value “the client and server establish sessions before communicating with the messages” is associated with the “description” sub-tag.

In the present embodiment, the value associated with the name sub-tag is a short description of the task, whereas, the value associated with the description sub-tag is a long optional description of the task that may be specified if the name is not descriptive enough. In one embodiment, the description does not appear in the status report. However, a user may request to see the description by interacting with a user interface in the status report. For example, when viewing the status report the project manager may select a button, which causes the description to appear.

In the present embodiment, the work to complete tasks is performed in time periods or cycles. For example, as depicted in Table 1, the tasks for message type A and message type B are scheduled to be completed in the first cycle. Similarly, the tasks for protocol sessions and the protocol state machine are scheduled to be completed in the second cycle.

In the present embodiment, the work for completing tasks in a cycle is divided into phases. In the present embodiment, these phases include, but are not limited to: design, code, and test. Phase-states are associated with each phase to indicate the progress that has been made during that phase. For example, these phase-states include, but are not limited to: planned, in progress, review needed, reviewed, and done. In the present embodiment, each time period or cycle moves through each phase and each phase moves through each of the phase-states as the work progresses.

For example, as depicted in Table 1, the work for messages type A and B is to be completed in cycle 1. First the programmers plan to start designing message type A and message type B (e.g., phase=design, phase-state=planned), then they actually start designing the messages (e.g., phase=design, phase-state=in progress), when they complete the design of the messages, a design review is needed (e.g., phase=design, phase-state=review needed), then the design of the messages is reviewed (e.g., phase=design, phase-state=reviewed), and finally the design of the messages is completed (e.g., phase=design, phase-state=done). Similarly, the work for coding (e.g., phase=code) and testing (e.g., phase=test) messages type A and B each move through the “planned”, “in progress”, “review needed”, “reviewed”, and “done” phase-states. Then the work for the tasks—protocol sessions and protocol state machine—in the second cycle go through a similar process.

In the present embodiment, as illustrated in Table 1, the format of the data conforms to the syntax for Java Documentation Comments. Java Documentation Comments are used for entering data into the comments of Java source code files. For example, as programmers perform work on source code file 202 or 204 the programmers might enter data, as depicted in Table 1, into the comments of the source code files 202 and 204, thus, creating data describing the status of tasks 206 and 208, respectively.

The Java Documentation Generator, also known as Javadoc, retrieves the data from the comments of the Java source code files, formats the data, and generates reports, which display the formatted data to an interested user, such as a project manager. The initial summary sentence of any Java Documentation Comment begins with the “@” character, thus designating tags that enable the Java Documentation Generator to identify the data it may retrieve from the comments. For example, on lines 1, 9, 20, and 26, the “@” character is used to designate task tags. In which case, the Java Documentation Generator may retrieve the data associated with each task tag. For example, the Java Documentation Generator may retrieve the data on lines 1-7 for the first task tag, lines 9-18 for the second task tag, lines 20-24 for the third task tag, and lines 26-30 for the fourth task tag.

Since, in the present embodiment, the format of the data that describes the status of tasks conforms to an industry-standard, cross-platform solutions may be used for parsing, processing, and printing out the data. For example, in one embodiment, the code that: (1) recognizes the tags, sub-tags, and the values associated with the sub-tags, and (2) processes the tags, sub-tags, and the values is implemented in a doclet that the Java Documentation Generator invokes, as will be described in more detail. In one embodiment, the status report generator 212 includes the Java Documentation Generator and the doclet.

### The Status Report

In the present embodiment, the information in the status report 214 may be depicted in any visual format. For example, the information may be depicted in a tabular format, in charts, graphs, bar graphs, etc.

In one embodiment, information in the status report may be broken out or aggregated in any manner that may be useful. For example, the status of tasks that each individual programmer is currently working on may be depicted separately or aggregated in some manner. Specifically, it may be useful to report that programmer x is 90% finished implementing a particular task in source code file 202 and programmer z is 10% finished implementing a different task in source code file 204. Alternatively, the data describing the status of tasks that are to be completed in a particular time period may be aggregated together to determine whether the software project is on target for that time period. Further, the data describing the status of tasks may be aggregated for a particular individual, for a team of people, or for the software project to provide a product perspective.

In one embodiment, the status report may be produced in any form or format. In one embodiment, industry standard tools, such as the Java Documentation Generator or Doxygen, are used for generating the status report, thus, the form and the format of the status report are easy to modify. For example, the industry standard tools make it easy to change the form of the status report from an XML document to a PDF, among other things. Similarly, the format may easily be modified by, among other things, adding more tags and/or sub-tags.

In one embodiment, the status report is generated at pre-specified intervals. For example, the status report may be generated every hour. In another embodiment, the status report is generated when a user requests it.

In one embodiment, the status report is stored in a convenient place for users to access, such as on a web server.

### Operational Examples

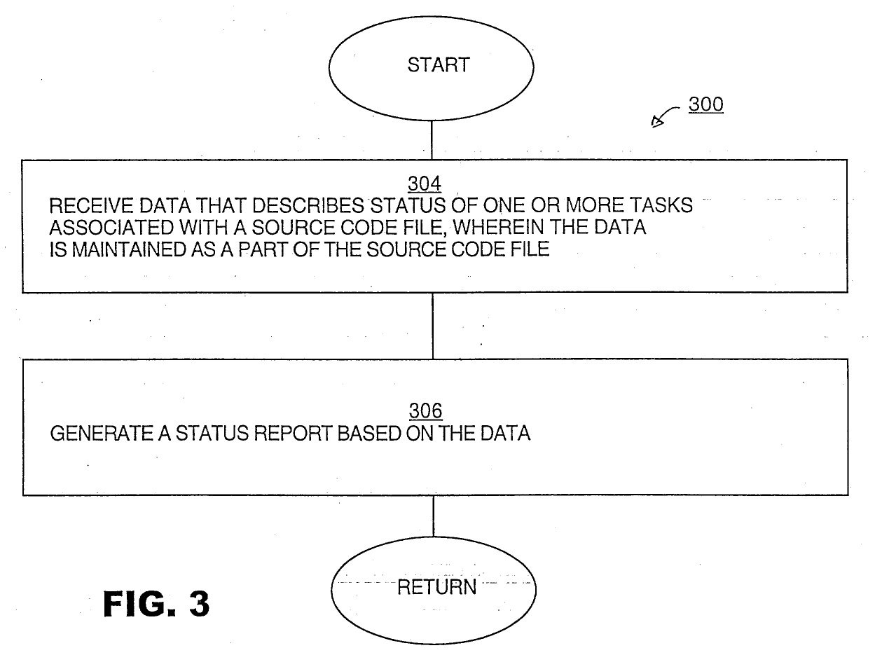

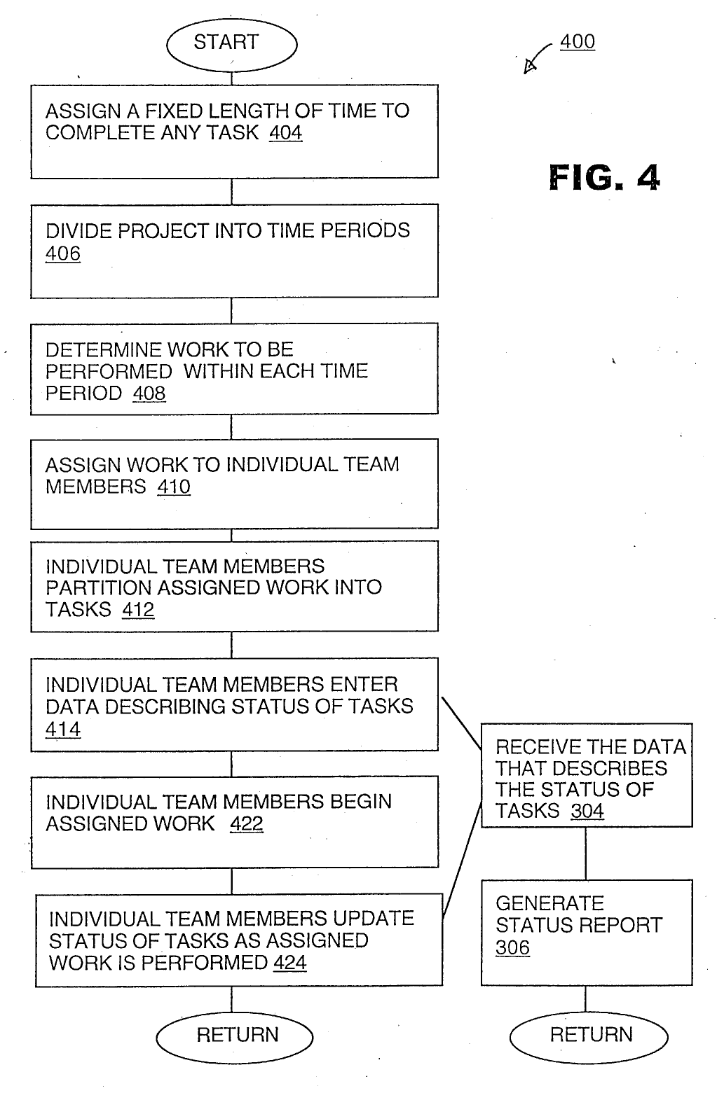

FIG. 3 and FIG. 4 depict flowcharts 300 and 400 respectively for generating a status report from source code according to embodiments of the present invention. Although specific steps are disclosed in flowcharts 300 and 400, such steps are exemplary. That is, embodiments of the present invention are well suited to performing various other steps or variations of the steps recited in flowcharts 300 and 400. It is appreciated that the steps in flowcharts 300 and 400 may be performed in an order different than presented, and that not all of the steps in flowcharts 300 and 400 may be performed. All of, or a portion of, the methods described by flowcharts 300 and 400 can be implemented using computer-readable and computer-executable instructions which reside, for example, in computer-usable media of a computer system or like device. In the present embodiment, steps 304 and 306 are implemented in the status report generator 212 of FIG. 2.

In the present embodiment, certain steps are taken to prepare for the steps illustrated in FIG. 3. As illustrated in FIG. 4, the preparatory steps are 404, 406, 408, 410, 412, and 414, as will be described hereinafter.

For the purposes of illustration, the discussion of flowcharts 300 and 400 shall refer to: (1) the structures depicted in FIG. 2., and (2) the data that describes the status of tasks, as depicted in Table 1. Further, for the purposes of illustration, assume that: (3) all four tasks—protocol sessions, protocol state machine, message type A, message type B—as depicted in Table 1, are to be implemented in source code file 202. Additionally, for the purposes of illustration, assume that the status report generator 212 includes a Java Documentation Generator and a doclet that: (1) recognizes the tags, sub-tags, and the values associated with the sub-tags, as depicted in Table 1, and (2) processes the tags, sub-tags, and the values.

In step 404, a fixed length of time to complete any task is assigned. For example, 3 days may be assigned as the fixed length of time to complete any task.

In step 406, the software project is divided into time periods. For example, a software project for implementing a communications protocol may be divided into two time periods, which are also known as cycles.

In step 408, the work to be performed within each time period is determined. For example, a determination may be made to complete the different messages in the first time period (e.g., cycle=1) and to complete basic services that the protocol uses in the second time period (e.g., cycle=2).

In step 410, the work is assigned to the individual team members. For example, the basic services that the protocol uses may be assigned to John while the message type A may be assigned to Shane and message type B may be assigned to Cheryl.

In step 412, the individual team members partition the assigned work into tasks. For example, in step 404, 3 days was assigned as the fixed length of time to complete any task . Therefore, the individual team members partition their assigned work into tasks that can be completed in 3 days. John may decide that the basic services may be partitioned into two tasks—one task for completing the protocol sessions and a second task for completing the protocol state machine. Shane and Cheryl may both decide that their respective message types can be completed in one task.

In the present embodiment, if the amount of work that has been assigned to a task cannot be completed in the fixed length of time to complete any task, then the work is broken into additional tasks that can be completed in the fixed length of time. For example, if a particular task x requires 6 days of work and the fixed length of time for any task is 3 days, then task x may be divided into two tasks x1 and x2.

In step 414, the individual team members enter data describing the status of tasks. In the present embodiment, data describing the status of tasks 206 is entered into source code file 202 before a status report 214 is generated to ensure that meaningful and accurate information is in the status report 214. For example, in the present embodiment, the programmers enter the data that describes the status of all tasks for the entire software project at the beginning of the software project. Thus, accurate percentages of completed work can be computed for the status report 214. Continuing the example, if at a future time, one of the four tasks has completed the test phase, then 25% (e.g., ¼) of the project is completed. In this example, the percentage of completed work is reported based on work completed for the entire project.

In an alternative embodiment, the percentages of completed work are reported based on work completed for cycles. Continuing the previous example, the project has two cycles with two tasks in each cycle. The work on one of the tasks for one of the cycles has completed so 50% (e.g., ½) of one of the cycle has completed. In yet another embodiment, the percent of completed work for a particular phase within a cycle or project can be reported.

In one embodiment, the programmers enter data that describes the status of less than all the tasks for the entire software project. For example, the programmers may enter data that describes the status of the tasks for a particular cycle.

In one embodiment, the percent of entered data may be estimated in order to compute other percentages. For example, if the programmers entered data that describes the status of three tasks when the entire project is estimated to have four tasks, the project manager may estimate that 75% of the data was entered for the project and use the 75% estimate to compute the percentages of completed work.

In one embodiment, the individual team members may agree upon a date by which the source code files, for a particular cycle or for the entire project, are to be created and the data describing the status of the tasks for that cycle or project is to be entered into the respective source code files.

Continuing the example, at this point in time, the John, Shane, and Cheryl may be planning their designs, in which case, they may create source code file 202 and enter data, similar to that found in Table 1, into the comments of source code file 202. John may enter “phase=design” and “phase-state=planned” into comments associated with source code file 202 for the protocol sessions and the protocol state machine tasks resulting in the creation of data describing the status of tasks 206. Similarly, Shane enter “phase=design” and “phase-state=planned” into comments associated with source code file 202 for the message type task, thus, adding data to the data describing the status of tasks 206. Cheryl would do the same for the message type B task. In the present embodiment, the data describing the status of tasks 206 is maintained as a part of the comments of source code file 202.

In step 304, the data that describes the status of the tasks is received. In the present embodiment, the status report 214 is generated at a pre-specified interval. For example, once data describing the status of tasks 206 is initially entered in step 414, the status report generator 212 may be scheduled to execute on system 190 every hour to generate a status report 214. On an hourly basis, the status report generator 212 interacts with source code file 202 to receive data describing the status of tasks 206.

In step 306, a status report is generated based on the data. In the present embodiment, the status report generator 212 generates the status report 214 based on the data it received in step 304.

In one embodiment, the status report generator 212 sorts the data describing the status of tasks 206. The data describing the status of tasks 206 may be sorted, among other things, by tasks, by cycles, by phases, and/or by phase-states. In one embodiment, the data describing the status of tasks 206 sorts the tasks by cycles, then each task within each cycle is sorted by phases, which in turn are sorted by phase-states.

In the present embodiment, the status report generator 212 includes a Java Documentation Generator and a doclet. The Java Documentation Generator invokes the doclet, which parses the data describing the status of tasks 206 on behalf of the Java Documentation Generator to determine what the tags, sub-tags, and values are. The Java Documentation Generator uses the parsed data to generate the status report 214.

To continue the example, the status report 214 would indicate that the programmers plan to start designing the work assigned to them since the programmers entered “phase=design” and “phase-state=planned” in step 414.

In step 422, the individual team members begin their assigned work. For example, John, Shane, and Cheryl begin working on their designs.

In step 424, the individual team members update the status of tasks as the assigned work is performed. For example, as John, Shane, and Cheryl design, code, and test their respective tasks they also update the data describing the status of the tasks 206 in the source code file 202. For example, John, Cheryl, and Shane may update the phase and phase-state sub-tags associated with the data describing the status of the tasks 206 to indicate the phases and phase-states they are working on as already described herein. Specifically, if Shane and Cheryl have completed testing the code for message type A and B, then the data describing the status of tasks 206 would have “phase=test” and “phase-state=done”.

Updating the data describing the status of tasks is convenient since programmers can update the data as they work on the source code files. Thus, real-time data is always available for generating a status report 214.

In step 304, the data that describes the status of the tasks is received. For example, on an hourly basis, the status report generator 212 may be scheduled to receive data describing the status of tasks 206 from source code file 202.

In the present embodiment, the data that describes the status of all entered tasks is received in step 304 both after the data is initially entered (step 414) and after the data is updated (step 424). In an alternative embodiment, the data that describes the status of all entered tasks is received in step 304 after the data is initially entered (step 414), however, only the modified portions of the data is received in step 304 after the data is updated (step 424).

In step 306, a status report is generated based on the data. In the present embodiment, the status report generator 212 generates the status report 214 based on the data it received in step 304. The status report 214 reflects the updates the individual team members made in step 424. For example, the status report 214 would reflect that Shane and Cheryl have completed testing message type A and message type B.

The following is a discussion of an alternative embodiment to that discussed above for flowcharts 300 and 400. For the purposes of illustration, assume that the tasks for protocol sessions and state machine (refer to lines 1 and 9 of Table 1) are to be implemented in source code file 202. Further, assume that message type A and message type B (refer to lines 20 and 26 of Table 1) are to be implemented in source code file 204.

Steps 404, 406, 408, 410, and 412 remain unchanged.

In step 414, the individual team members enter data describing the status of tasks. For example, since protocol sessions and state machine are implemented in source code file 202, John would enter data similar to that on lines 1 to 9 of Table 1 into the comments of source code file 202, thus, creating data describing the status of tasks 206. Likewise, since message type A and message type B are implemented in source code file 204, Cheryl and Shane would enter data similar to that on lines 20 to 26 of Table 1 into the comments of source code file 204, thus, creating data describing the status of tasks 208.

At this point in time, the programmers may be planning their designs, in which case, the data describing the status of tasks 206 and 208 may include “phase=design” and “phase-state=planned” for each task tag.

In a step that is analogous to step 304, the data that describes the status of the tasks is received. For example, on an hourly basis, the status report generator 212 may be scheduled to interact with source code files 212 and 204 to receive data describing the status of tasks 206 and 208.

In a step that is analogous to step 306, a status report is generated based on the data. In the present embodiment, status report generator 212 generates the status report 214 based on the data it received in the previous step.

In the present embodiment, the status report generator 212 includes a Java Documentation Generator and a doclet. The Java Documentation Generator invokes the doclet, which parses the data describing the status of tasks 206 and 208 on behalf of the Java Documentation Generator to determine what the tags, sub-tags, and values are.

In step 422, the individual team members begin their assigned work. For example, John, Shane, and Cheryl begin working on their designs.

In step 424, the individual team members update the status of tasks as the assigned work is performed. For example, as John, Shane, and Cheryl design, code, and test their respective tasks they also update the data describing the status of the tasks 206 and 208 in the source code files 202 and 204. Specifically, if John has completed designing the protocol sessions and the protocol state machine, then the data describing the status of tasks 206 would have “phase=design” and “phase-state=done” for the protocol sessions and the protocol state machine tasks. Similarly, if Shane and Cheryl have completed testing the code for message type A and B, then the data describing the status of tasks 208 would have “phase=test” and “phase-state=done” for the message type A and B tasks.

In the step that is analogous to step 304, the data that describes the status of the tasks is received. For example, on an hourly basis, the status report generator 212 may be scheduled to receive data describing the status of tasks 206 and 208 from source code files 202 and 204 respectively. The data describing the status of tasks 206 and 208 reflects the updates the individual team members made in step 424.

In the step that is analogous to step 306, a status report is generated based on the data. To continue the example, the status report generator 212 generates the status report 214 based on the data it received in the previous step. The status report 214 reflects the updates the individual team members made in step 424. For example, the status report 214 would reflect that John finished designing the protocol sessions and the protocol state machine. Similarly, the status report 214 would reflect that Shane and Cheryl had completed testing message type A and message type B.

### Conclusion

Partitioning assigned work into tasks (step 412), entering data describing the status of tasks (step 414), and updating the data (step 424) provide sufficient granularity to accurately track the work performed on source code files. For example, work on some tasks within a particular source code file may be further along than work on other tasks within the same source code file. Since work is tracked by tasks, a more detailed report can be generated not only for various tasks associated with the particular source code file but also for the entire software project.

Tasks can be broken out in as small a granularity as the project manager desires. For example, a project manager may assign a 10 day fixed length of time for completing any task or a 1 day fixed length of time, thus, providing more or less granularity for tracking data. Similarly, progress can be tracked, among other things, based on individuals, teams, or projects.

By using an industry-standard format when entering the data that describes the status of tasks (step 414), when updating the data (step 424), when receiving the data (step 304), and when generating a status report based on the data (306), existing software tools, such as the Java Documentation Generator and a doclet, can be used in implementing the Status Report Generator 212, thus, a cross-platform solution is achieved.

By using an industry-standard format, the functionality of the status report generator is easy to maintain and extend. For example, new tags and/or sub-tags, among other things, can be easily added or the form of the status report may easily be modified, among other things, from PDF to XML or vis versa. These modifications can be done programmatically.

By using an industry-standard format, data describing the status of new tasks can easily be entered into source code files for future cycles, thus, providing early tracking of work that will be performed in the future.

By maintaining the data that describes the status of as a part of the source code files (steps 414 and 424), real-time data is always available for generating the status report 214 because maintaining the data is easy.

### Extensions and Alternatives

Although certain embodiments of the present invention were described using certain tags and sub-tags, the present invention is not limited to the tags and sub-tags described herein. For example, a date-to-start sub-tag may be associated with the tasks allowing programmers to indicate a specific date when they plan to start working on the indicated phase for a particular task. Similarly, a time-allotted sub-tag may be associated with the tasks allowing programmers to indicate the amount of time they think a particular task may take.

Although certain embodiments of the present invention were described using Java Document Comments as the industry-standard format, other industry-standard formats, such as XML, may be used.

Although certain embodiments of the present invention were described using Java Documentation Generator and a doclet, other cross-platform tools, such as Doxygen, may be used.

Although certain embodiments of the present invention were described using Java and entering data describing the status of tasks into Java comments, the Javadoc style of commenting can be used to comment source code files written in many languages, such as C++.

Embodiments of the present invention are thus described. While the present invention has been described in particular embodiments, it should be appreciated that the present invention should not be construed as limited by such embodiments, but rather construed according to the following claims.

What is claimed is:

1. A method of generating a status report from source code, the method comprising:
receiving data that describes status of one or more tasks associated with a source code file, wherein the data is maintained as a part of the source code file; and
generating the status report based on the data.

2. The method of claim 1, wherein the source code file is a first source code file and the data is first data, and wherein the method further comprises:
receiving second data that describes status of one or more tasks associated with a second source code file, wherein the second data is maintained as a part of the second source code file; and
generating the status report based on the first data and the second data.

3. The method of claim 1, wherein a format of the data conforms to an industry-standard.

4. The method of claim 1, wherein the one or more tasks represent one or more partitions of work to be performed on the source code file, and wherein the method further comprises:
receiving the data that describes the status of the one or more partitions of work.

5. The method of claim 1, wherein the step of receiving the data further comprises:
receiving data that describes updates to the status of the one or more tasks.

6. The method of claim 1 further comprising:
determining work to be performed on the source code file within a given time period; and
partitioning the work into the one or more tasks.

7. The method of claim 1, wherein the data is maintained as a part of comments associated with the source code file.

8. A computer system comprising:
a memory unit; and
a processor coupled to the memory unit, the processor for executing a method for generating a status report from source code, the method comprising:
receiving data that describes the status of one or more tasks associated with a source code file, wherein the data is maintained as a part of the source code file; and
generating the status report based on the data.

9. The computer system of claim 8, wherein the source code file is a first source code file and the data is first data, and wherein the method further comprises:
receiving second data that describes status of one or more tasks associated with a second source code file, wherein the second data is maintained as a part of the second source code file; and
generating the status report based on the first data and the second data.

10. The computer system of claim 8, wherein a format of the data conforms to an industry-standard.

11. The computer system of claim 8, wherein the one or more tasks represent one or more partitions of work to be performed on the source code file, and wherein the method further comprises:
receiving the data that describes the status of the one or more partitions of work.

12. The computer system of claim 8, wherein the step of receiving the data further comprises:
receiving data that describes updates to the status of the one or more tasks.

13. The computer system of claim 8, wherein the method further comprises:
determining work to be performed on the source code file within a given time period; and
partitioning the work into the one or more tasks.

14. The computer system of claim 8, wherein the data is maintained as a part of comments associated with the source code file.

15. A computer-usable medium having computer-readable program code embodied therein for causing a computer system to perform a method of generating a status report from source code, the method comprising:
receiving data that describes status of one or more tasks associated with a source code file, wherein the data is maintained as a part of the source code file; and
generating the status report based on the data.

16. The computer-usable medium of claim 15, wherein the source code file is a first source code file and the data is first data, and wherein the computer-readable program code embodied therein causes a computer system to perform the method, and wherein the method further comprises:
receiving second data that describes status of one or more tasks associated with a second source code file, wherein the second data is maintained as a part of the second source code file; and
generating the status report based on the first data and the second data.

17. The computer-usable medium of claim 15, wherein a format of the data conforms to an industry-standard.

18. The computer-usable medium of claim 15, wherein the one or more tasks represent one or more partitions of work to be performed on the source code file, wherein the computer-readable program code embodied therein causes a computer system to perform the method, and wherein the method further comprises:
receiving the data that describes the status of the one or more partitions of work.

19. The computer-usable medium of claim 15, wherein the computer-readable program code embodied therein causes a computer system to perform the method, and wherein the step of receiving the data further comprises:
receiving data that describes updates to the status of the one or more tasks.

20. The computer-usable medium of claim 15, wherein the computer-readable program code embodied therein causes a computer system to perform the method, and wherein the method further comprises:
determining work to be performed on the source code file within a given time period; and
partitioning the work into the one or more tasks.

21. The computer-usable medium of claim 15, wherein the data is maintained as a part of comments associated with the source code file.
